(19) United States
(12) Patent Application Publication
(10) Pub. No.: US 2004/0093957 A1
(43) Pub. Date: May 20, 2004

(54) Apparatus for the measurement of the flow speed and/or the molar mass of gases or gas mixtures

(76) Inventors: Christian Buess, Zurich (CH); Erich Kleinhappl, Waedenswil (CH)

Correspondence Address: Rocco S. Barrese, Esq., DILWORTH & BARRESE, LLP, 333 Earle Ovington Blvd., Uniondale, NY, 11553, US

(21) Appl. No.: 10/196,780

(22) Filed: Jul. 17, 2002

(30) Foreign Application Priority Data
Jul. 17, 2001 (DE) 10134746.4
Nov. 20, 2001 (DE) 10156854.1

(51) Int. Cl. G01F 1/66

(52) U.S. Cl. 73/861.27

(57) ABSTRACT

The invention relates to an apparatus for the measurement of the flow speed and/or of the molar mass of gases or gas mixtures in a medical application by means of ultrasonic transit time measurement with a graduated tube and two ultrasonic transducers which can be placed into this and which are separated from the interior space of the graduated tube via membranes. In accordance with the invention, the membranes are gas impermeable and are inserted into the graduated tube such that this forms a gas impermeable tubular connection. The ultrasonic transducers connected in a reseparable manner to the graduated tube contact the membranes in a flush manner.

The invention relates to an apparatus for the measurement of the flow speed and/or of the molar mass of gases or gas mixtures in a medical application by means of ultrasonic transit time measurement.

A so-called ultrasonic spirometer is already known from DE 42 22 286 C in which, to avoid cross-infections, the use of an easily replaceable, largely sterile respiratory tube is recommended which can be inserted into the graduated tube. This respiratory tube has measuring windows at the transition to the measuring path such that inserts can be inserted into corresponding openings which are permeable for ultrasonic waves, but largely impermeable for germs and contamination. In this solution, the ultrasonic transducers respectively forming the transmission cell pair and the reception cell pair are arranged obliquely to the graduated tube axis in a measuring path. It is hereby caused that chambers are formed at the side at the graduated tube and the respective ultrasonic transducers are seated in these. These chambers attached at the side, however, result in the fact that on the determination of the molar mass not only the gas disposed in the measuring path is determined but also the gas or gas mixture disposed in the chambers.

It is the object of the invention to further develop an apparatus of this kind for the measurement of the flow speed and/or of the molar mass of gases or gas mixtures in a medical application by means of an ultrasonic transit time measurement such that in the ultrasonic measurement of the molar mass only the molar mass of the gas in the measuring path is determined, with full sterilisation capability of the exchangeable measurement tube.

This object is solved in accordance with the invention by the feature combination of claim 1. In accordance with this solution, starting from the generic apparatus, the membranes are made in a manner impermeable to gas and are inserted into the graduated tube such that this forms a tubular connection impermeable to gas. The ultrasonic transducers contact the respective membranes in a flush manner.

The main application of this solution lies in the use of a corresponding apparatus for the measurement of the respiratory flow speed and the respiratory gas composition in normally breathing patients or patients on ventilators. In this application, the apparatus in accordance with the invention can be interposed in the respiratory flow or the respiratory circuit. Diverse parameters important for the diagnosis of the pulmonary function can be determined on the basis of the parameters measured (flow speed, molar mass, pressure). Examples for this are tidal volumes, the functional residual capacity, which can be determined by means of washing out or washing in methods and an analysis of flow speed and molar mass, and diagrams which represent the relationship between pressure, flow speed, molar mass or volume.

Preferred embodiments of the invention result from the subordinate claims dependent on the main claim.

The membranes can be arranged such that the ultrasonic measuring path is parallel to the axis of symmetry of the tube.

In accordance with an advantageous aspect, the connections for the supply of the gas can be set on the side of the tube, i.e. perpendicular to the axis of the graduated tube.

Electronic means are preferably present with whose help the flow speed and/or the molar mass can be calculated from the transit times of the ultrasonic pulses coupled into the graduated tube via the membrane.

In addition, one or more measuring sensors can be present to determine the gas temperature and/or the housing temperature.

The flow is preferably calculated according to the following formula known per se:

$$F = k \frac{{t}_{1} - {t}_{2}}{{t}_{1} \cdot {t}_{2}}$$

where F is the flow speed, t₁ and t₂ are the transit times of the ultrasonic pulses measured by means of the ultrasonic transit time measurement and k is a dimensionally adjusted constant.

The molar mass of the gases or gas mixtures is preferably calculated in accordance with the formula also already known per se:

$$M = k \cdot T \cdot {( \frac{{t}_{1} \cdot {t}_{2}}{{t}_{1} + {t}_{2}} )}^{2}$$

where M is the molar mass, T is the temperature of the gas determined by means of assumptions and/or of a mathematical model and/or of a measurement by means of one or more sensors present in the apparatus, k is a dimensionally adjusted constant and t₁ and t₂ are the transit times of the ultrasonic pulses measured by means of electronic circuits.

The ultrasonic transducers can be connected jointly or individually to the graduated tube, with the ultrasonic transducers preferably being able to be pressed onto the membranes individually or as a pair by means of a mechanical tensioning device. The graduated tube is therefore separable from the ultrasonic transducers and easily replaceable as a whole for cleaning or disinfecting or, with disposable use, for disposal.

The membranes can be made of plastic or metal.

The preferably piezo-ceramic ultrasonic transducers can additionally be provided with an impedance matching layer.

A gel-like bridging substance, a so-called “ultrasonic transmission gel” can additionally be introduced between the impedance matching layer and the membrane.

The quality of the sound transmission by the membranes can be monitored and/or controlled by means of a received signal amplitude measurement.

The gas pressure in the graduated tube can be measured by means of a suitable pressure sensor for the calculation of additional parameters. This pressure monitoring is in particular desirable with the use of the apparatus in intensive care medicine.

The ultrasonic transducer or its impedance matching layer can particularly advantageously have an arched surface. A particularly good connection between the ultrasonic transducer, on the one hand, and the membrane, on the other hand, is possible by this arched surface. Air inclusions are in particular prevented since, when the ultrasonic transducer is coupled in, the air disposed between the surface of the ultrasonic transducer and the membrane is outwardly displaced to the edge and thus cannot collect at the centre of the ultrasonic transducer.

In accordance with another articular aspect of the invention, the membranes are not inserted directly into the base body of the graduated tube, but via a suspension consisting of an attenuation ring. This suspension consisting of the attenuation ring serves to suppress structure borne signals, i.e. ultrasonic signals, which are not transmitted via the air, but via the base body from transducer to transducer.

Further details and advantages of the invention will be explained in more detail with reference to an embodiment represented in the drawing. There are shown

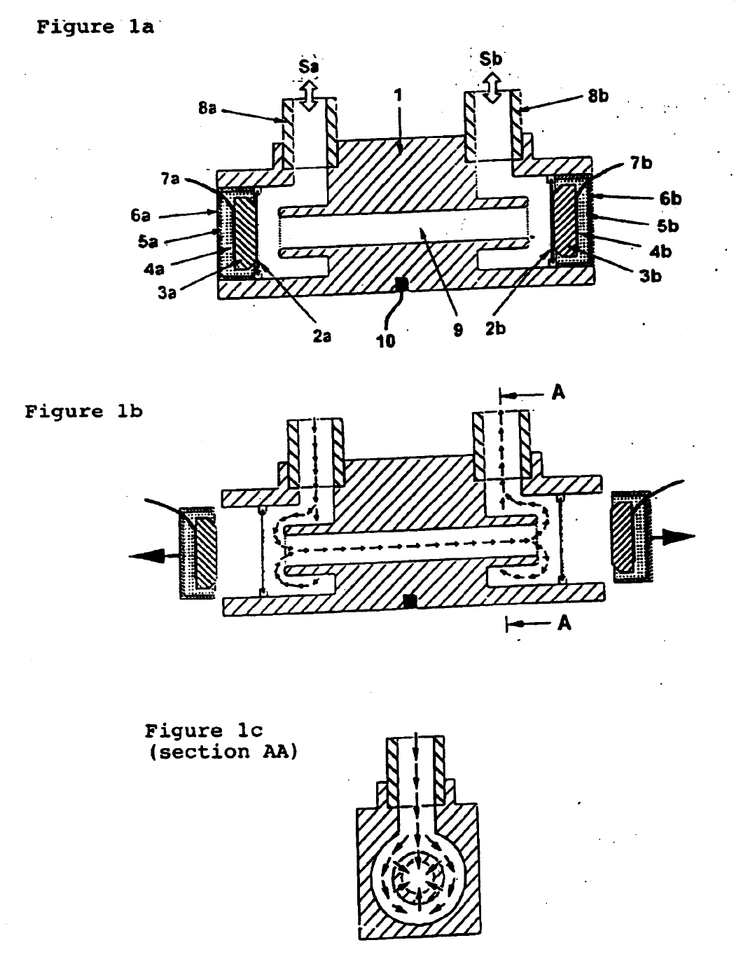

FIG. 1a: a sectional representation through a first variant of the apparatus in accordance with the invention;

FIG. 1b: a sectional representation corresponding to FIG. 1a in which the ultrasonic transducers are separated from the graduated tube and in which the gas flow is entered;

FIG. 1c: a section along the sectional line A-A through FIG. 1b;

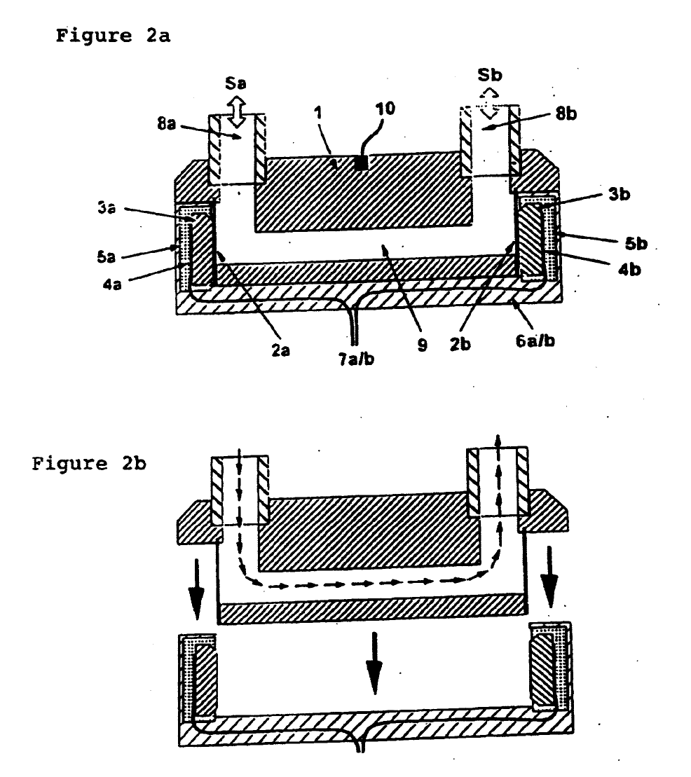

FIG. 2a: a sectional representation through a second variant of the apparatus in accordance with the invention;

FIG. 2b: a sectional representation corresponding to FIG. 2a in which the ultrasonic transducers are separated from the graduated tube and in which the gas flow is shown by arrows; and

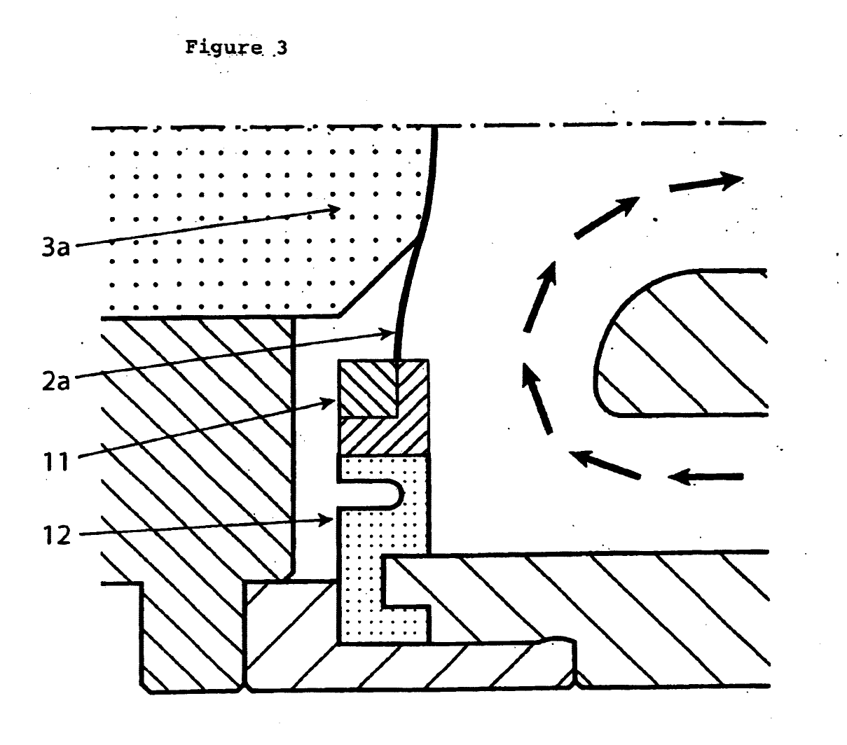

FIG. 3: a sectional representation through a detail of another variant of the apparatus in accordance with the invention.

A realisation variant of the apparatus with individually mountable ultrasonic transducers is shown in FIGS. 1a, 1b, 1c. The actual graduated tube consists of a base body 1 with embedded membranes 2a and 2b which are made of plastic or metal. These membranes are made in a gas impermeable manner. This respiratory tube can thereby be connected impermeably to the respiratory circuit via connectors 8a and 8b even without mounted ultrasonic transducers 3a, 3b to 7a, 7b. The connectors 8a and 8b are each arranged perpendicular to the axis of symmetry of the graduated tube such that the graduated tube has almost a U shape. In the present case, air Sa or Sb flows via a connector, for example the connector 8a, into the measuring apparatus, is led into an actual measurement passage 9 and flows via the opposite connector, for example the connector 8b, out of the measurement system again.

The graduated tube 1, 2a or 2b contains only mechanical parts and can thus be cleaned or disinfected without problems. Alternatively, the graduated tube can, however, also be made as a disposable part and thus serve for disposable use. This means that a respective new graduated tube is used per patient.

Two ultrasonic transducers are placed onto the base body 1 to determine the flow speed and/or the molar mass of the gases in the measurement passage 9. The ultrasonic transducers consist of an impedance matching layer 3a and 3b, a piezo-ceramic material 4a and 4b to produce the ultrasound, an attenuation layer 5a and 5b-multi-stage under certain circumstances, a holder 6a and 6b and connector wires 7a and 7b. When the ultrasonic transducers are placed on, the impedance matching layer is brought into direct connection with the membrane 2a and 2b.

To determine the sound transit times, one of the two ultrasonic transducers is excited by a pulse waveform. The sound wave produced by means of the piezo-ceramic material 4a is transmitted into the measurement passage via the impedance matching layer 3a and the membrane 2a and is received by the oppositely disposed ultrasonic transducer after passing through the measurement path. The transit time tᵢ of the ultrasonic wave is determined by means of a downstream electronic system which is not shown in any more detail here. A short time after the sound transmission from transducer side a to transducer side b, the transmission direction is changed and the sound transit time t₂ from the transducer side b to the transducer side a can be determined. The flow speed can now be determined by means of known processes from two sound transit times t₁ and t₂.

If, in addition to the measurement of the sound transit times, the temperature of the respiratory gas in the measurement passage is determined, then the molar mass of the bases can likewise be calculated. The determination of the temperature can be made by means of measurement, by means of assumption or by means of suitable mathematical models or by means of combinations of these methods. For this purpose, one or more temperature sensors 10 can be present in the base body 1.

It is shown in FIG. 1b that the ultrasonic transducers 3a, 3b to 7a, 7b are separable from the base body 1 by a corresponding pulling out in the direction of the arrow. The flow direction of the gas or of the gas mixture is shown by the arrows in FIGS. 1b and 1c.

A realisation variant of the apparatus in accordance with the invention is shown in FIGS. 2a and 2b with jointly exchangeable ultrasonic transducers. The two ultrasonic transducers are pushed directly over the membranes in this realisation variant. The latter are fastened to the base body 1 of the graduated tube, for example by means of welding. The air flow is led into the measurement passage in a different manner with respect to the apparatus in FIG. 1b.

Various further variants of the apparatus are possible. For example, the variant shown, for instance in FIGS. 1a to 1c, can also be produced with jointly exchangeable ultrasonic transducers. In this case, the transducers are clamped on with a tong-like apparatus such as is shown in the exploded representation in accordance with FIG. 2b. It becomes clear here that the tong-like apparatus can be pulled off from the base body 1 with the ultrasonic transducers in the direction of the arrow and connected to this again against this direction of the arrow

The ultrasonic transducers or impedance matching layers correspondingly provided on these are made in arched manner in a manner not shown more detail here such that the gas impermeable membranes 2a, 2b fit snugly and tightly to their surface. An improved coupling is hereby achieved between the ultrasonic transducers and the gas impermeable membranes.

In the sectional representation in accordance with FIG. 3, a detail is shown from which the oscillating suspension of the gas impermeable membrane 2a is shown. This is connected via a holder 11 to an attenuation ring 12, with the attenuation ring being anchored in the base body of the graduated tube 1. As can be seen from FIG. 3, the ultrasonic transducer 3a contacts the surface of the membrane 2a. To allow the oscillating suspension, the attenuation ring is made from a flexible material, with it additionally supporting the elastically resilient property by its shape. It is prevented by the oscillating suspension of the membrane 2a that ultrasonic signals are transmitted from transducer to transducer via the base body of the graduated tube. The structure borne signals which interfere with the measurement are therefore avoided.

1. An apparatus for the measurement of the flow speed and/or of the molar mass of gases or gas mixtures in a medical application by means of ultrasonic transit time measurement with a graduated tube and two ultrasonic transducers which can be placed into this and which are separated from the interior space of the graduated tube via membranes,
characterised in that
the membranes are gas impermeable and are inserted into the graduated tube such that this forms a gas impermeable tubular connection; and in that the ultrasonic transducers connected in a reseparable manner to the graduated tube contact the membranes in a flush manner.

2. An apparatus in accordance with claim 1, characterized in that the membranes are arranged such that the ultrasonic measurement path lies parallel to the symmetry axis of the tube.
